(19) United States
(12) Patent Application Publication
(10) Pub. No.: US 2022/0003194 A1
(43) Pub. Date: Jan. 6, 2022

(54) FUEL FILTER

(71) Applicants: Mahle International GmbH, Stuttgart (DE); Universitaet Innsbruck, Innsbruck (AT); Friedrich-Alexander-Universitaet- Erlangen-Nuernberg, Erlangen (DE); Karl-Franzens-Universitaet-Graz, Graz (AT)

(72) Inventors: Martin Hein, Stuttgart (DE); Peter Koppi, Sankt Margarethen (AT); Maria Kraut, St. Michael (AT); Avinash P. Manian, Dornbirn (AT); Frederik Mayer, Erlangen (DE); Birgit Renz, Marbach (DE); Julia Santer, St. Kanzian (AT); Sigurd Schober, Graz (AT)

(21) Appl. No.: 17/293,474

(22) PCT Filed: Nov. 12, 2019
(86) PCT No.: PCT/EP2019/081052

§ 371 Date: May 12, 2021

(30) Foreign Application Priority Data
Nov. 13, 2018 (DE) 102018219352.5

(51) Int. Cl. F02M 37/24; F02M 37/34; B01D 36/00; B01D 17/04; B01D 39/20

(52) U.S. Cl. CPC F02M 37/24; F02M 37/34; B01D 2239/1233; B01D 17/045; B01D 39/2017; B01D 36/003

(57) ABSTRACT

A fuel filter may include a housing and a coalescer arranged in the housing. The coalescer may be configured to separate out water contained in a fuel. The coalescer may include a coalescer material suitable for coalescing water. The fuel may be flowable through the coalescer in a throughflow direction. The coalescer material may include a plurality of fibres, which may have a primary orientation that is essentially parallel to the throughflow direction.

### CROSS-REFERENCE TO RELATED APPLICATIONS

This application claims priority to International Patent Application No. PCT/EP2019/081052, filed on Nov. 12, 2019, and German Patent Application No. 10 2018 219 352.5, filed on Nov. 13, 2018, the contents of both of which are hereby incorporated by reference in their entirety.

### TECHNICAL FIELD

The present invention relates to a fuel filter, in particular a diesel fuel filter, of an internal combustion engine, in particular of a motor vehicle, having a housing, in which there is arranged a coalescer. The invention relates in addition to a method for the production of a coalescer for such a fuel filter.

### BACKGROUND

Generally it is desirable, in fuel filters and in particular in diesel fuel filters, to separate off as much as possible a water component in the fuel, in order to hereby be able to guarantee a combustion which is as reliable as possible in the internal combustion engine. For this, two- or respectively three-stage filter systems have become established. In such filter systems, the first stage consists of a particle filter in order to be able to filter out contaminants/dirt particles from the fuel. The second stage is a so-called coalescer, in order to agglomerate the smallest water droplets. The agglomerated and enlarged water drops in the coalescer can subsequently sink gravimetrically to a water collector chamber or can be separated by a hydrophobic screen, which would then constitute a third stage.

From EP 2 788 612 B1 a generic fuel filter with a housing is known, in which a particle filter is arranged, to which downstream a coalescer is arranged for separating out water contained in the fuel. The coalescer comprises here at least one layer of a coalescer material which is suitable for the coalescence of water, wherein both the particle filter and also the coalescer are flowed through in a common flow direction. Provision is made here that a primary orientation of the fibres of the coalescer material runs transversely to the primary flow direction of the separated-out water. Hereby, the extensibility of the coalescer material, which is greater transversely to the fibre direction than longitudinally to the fibre direction, is to be increased.

### SUMMARY

The present invention is concerned with the problem of indicating, for a fuel filter of the generic type, an improved or at least an alternative embodiment, which in particular further improves a separating out of water contained in the fuel.

This problem is solved according to the invention by the subject matter of the independent claim(s). An advantageous embodiment is in the subject matter of the dependent claim(s).

The present invention is now based on the general idea of orienting fibres of a coalescer material no longer multidirectionally but rather unidirectionally, i.e. essentially parallel to one another and, at the same time, of arranging the coalescer material with respect to a throughflow direction in the fuel filter so that a primary orientation of the fibres of the coalescer material is oriented essentially parallel to the throughflow direction. The fuel filter according to the invention, which can be configured in particular as a diesel fuel filter of an internal combustion engine, in particular of a motor vehicle, has here a housing in which there is arranged a coalescer for separating out water contained in the fuel, which coalescer comprises a coalescer material that is suitable for the coalescence of water. According to the invention, the coalescer material now has fibres whose primary orientation is oriented essentially parallel to the throughflow direction. Hereby it is possible to optimize an agglomeration effect in the coalescer, because a distinctly lengthened contact of the water droplets with the fibres is achieved, because the water droplets move along the fibre surface. Hereby, an improved agglomeration and thus enlargement of the water drops can be brought about. By the fibres oriented in throughflow direction, in addition a pressure loss in the coalescer material falls, which has a positive effect on the operation of the fuel filter. With the fibres oriented according to the invention in the coalescer material, larger water droplets can be produced with identical thickness compared to a coalescer material with fibres which are oriented multidirectionally. A primary orientation of the fibres is not present here only when all the fibres run in a parallel manner, but also already when the running direction of over 50 percent, preferably even of over 80 or 90 percent, of the fibres has an angle of less than 45 degrees to a direction, which then represents the primary orientation.

Advantageously a particle filter is provided here, and the coalescer is arranged downstream of the particle filter. The particle filter and the coalescer are flowed through here in a common throughflow direction. Hereby, an optimized filter performance and separating out of water can be achieved. Purely theoretically, the filter material and the coalescer material can be realized in one medium, possibly by two layers with filter material and clean-side coalescer. Purely theoretically, also only one coalescer with fibres in throughflow direction can be installed, which carries out filtration and coalescence. In addition, it is conceivable that the coalescer and the particle filter are combined in a filter element, wherein such a filter element comprises coalescer and particle filter and is easy to operate.

In an advantageous further development of the solution according to the invention, the particle filter is configured as a ring filter element and the coalescer is configured to be ring-shaped in cross-section. In this case, a primary orientation of the fibres of the coalescer material lies in radial direction wherein, depending on whether the coalescer is arranged inside or outside the particle filter, the particle filter is flowed through from the outside inwards or from the inside outwards.

In a further advantageous embodiment of the solution according to the invention, the fibres of the coalescer material have a diameter D between 1 μm and 30 μm. Over a diameter lying in this range, the intermediate spaces remaining between the individual fibres can be optimized with regard to their diameter and with regard to an agglomeration effect. It is, of course, clear here that the individual fibres are not oriented exactly parallel to one another, but rather, viewed in one view, can also cross one another. It is important here only that the primary orientation of the fibres of the coalescer material, i.e. a primary orientation of the longitudinal direction of the fibres, is oriented parallel to the throughflow direction. A primary orientation of the fibres is not present here only when all the fibres run in a parallel manner, but also already when the running direction of over 50 percent of the fibres has an angle of less than 45 degrees to a direction which then represents the primary orientation. Preferably, over 80 percent or respectively even over 90 percent of the fibres have an angle of less than 45 degrees to the primary orientation direction. This can be easily determined optically.

In an advantageous further development of the solution according to the invention, the fibres of the coalescer material are configured as glass fibres. Glass fibres have a high resistance with respect to fuels and are thereby able to be used over a long term as coalescer material. Of course, alternatively also other materials can be used for the fibres of the coalescer material, such as for example fuel-resistant plastic, polyester, cellulose and/or metal.

The present invention is further based on the general idea of indicating methods for the production of a coalescer for a fuel filter described in the previous paragraphs, in which the coalescer material is produced by means of an aerodynamic nonwoven method, for example meltblown or spunbond methods, or a hydrodynamic nonwoven method (wetlaid nonwovens). The coalescer material can also be produced by means of knitting, warp-knitting, weaving or an electrospinning, wherein a fibre orientation in z-direction is provided, for example in an analogous manner to other applications, such as for example cleaning cloths, hand towels, etc. Basically, all nonwoven fabrics can be used. In principle all nonwovens can be used. Generally here a carding of the fibres can take place here by a parallel deposition (electrospinning) or by a subsequent mechanical orienting. In the spunbond method (spunbonded nonwoven), firstly endless fibres (filaments) are spun from a melt or solution. This takes place in the case of thermoplastic plastics directly in the melt-spinning process (spunmelt). For this, for example a polymer granulate is melted and fed to a spinneret. The exiting filaments are stretched immediately thereafter. In the meltblown method, the still-fluid filaments are torn by a hot air stream, whereby extremely fine individual fibres arise. Of course, staple fibres of natural and synthetic fibres can also be used.

After producing the individual plastic fibres by for example the methods previously described, these are deposited in a parallel manner or are subsequently carded in a multidirectional deposition, i.e. oriented, for example combed. Through this process it is achieved that the fibres are arranged essentially parallel to one another. Essentially parallel is intended to mean here that at least 50 percent of the fibres, preferably 80 percent or even 90 percent of the fibres are oriented parallel to one another or respectively parallel to a primary orientation.

These coalescer webs can then be further processed as follows:

Variant 1: Cutting to length the coalescer web transversely to the fibre longitudinal direction (y-direction) into individual coalescer web sections, wherein the cut-to-length coalescer web sections are turned through 90° and stuck to one another laterally, so that a coalescer mat results, or

Variant 2: Orienting of the fibres in y-direction, i.e. optimizing of the combing with subsequent folding (for orienting in z-direction).

In Variant 1 the produced coalescer web is cut off transversely to the machine direction (y-direction) and the cut-to-length coalescer web sections are subsequently turned through 90° and stuck to one another laterally, so that a coalescer mat results. Subsequently, the coalescer mat is rolled to a cylindrical ring filter and is stuck together at the ends. The fibres lie here in radial direction, parallel to the throughflow direction. Purely theoretically, it is of course also conceivable that the coalescer is configured as a polygon.

In Variant 2 the produced coalescer web is folded in an alternating manner about an x-axis and thereby a zigzag-shaped folded web is produced, in which the fibre longitudinal direction follows the zigzag shape. Subsequently, this folded web is cut to a bellows and, for example, is stuck into a coalescer frame, wherein an additional on-block pressing of individual folds takes place, in order to be able to bring about an almost parallel orientation of the fibres. The bellows can be heated here, wherein bicomponent fibres are used as fibres which, on heating, bring about a sticking together of individual folds of the bellows. It is essential that the fibres are flowed against in longitudinal direction and the folds stand closely to one another, so that the fluid can not flow into the fold, but rather is forced to flow through the fold longitudinally and thus the fibres are also flowed against in longitudinal direction.

Further important features and advantages of the invention will emerge from the subclaims, from the drawings and from the associated figure description with the aid of the drawings.

It shall be understood that the features mentioned above and to be further explained below are able to be used not only in the respectively indicated combinations, but also in other combinations or in isolation, without departing from the scope of the present invention.

Preferred example embodiments of the invention are illustrated in the drawings and are explained more closely in the following description, wherein the same reference numbers refer to identical or similar or functionally identical components.

### BRIEF DESCRIPTION OF THE DRAWINGS

There are shown, respectively schematically,

FIG. 1 shows a sectional illustration through a fuel filter according to the invention,

FIG. 2 shows a sectional illustration through a coalescer according to the invention,

FIGS. 3 and 4 show a method for the production of a fuel filter according to the invention.

### DETAILED DESCRIPTION

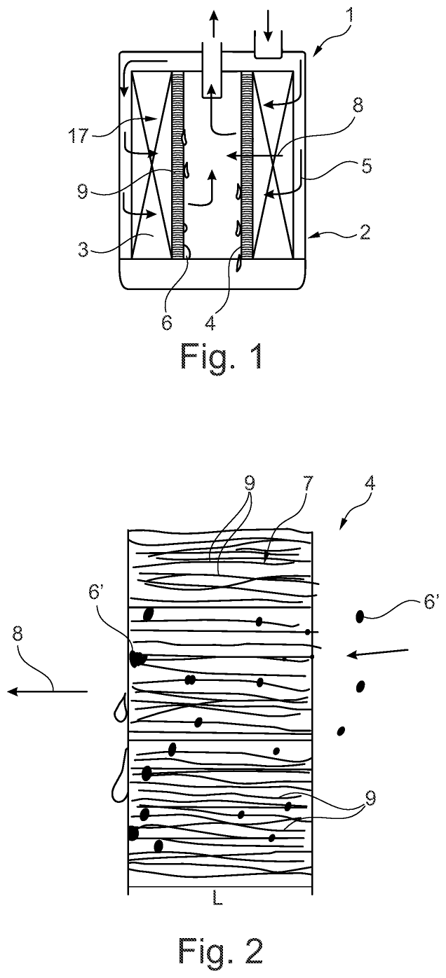

According to FIG. 1, a fuel filter 1 according to the invention, which can be for example a diesel fuel filter and is used in an internal combustion engine of a motor vehicle, has a housing 2 in which a particle filter 3 is arranged. There is arranged downstream of the particle filter 3 a coalescer 4 for separating out water 6 contained in fuel 5, wherein the coalescer 4 comprises at least one layer of a coalescer material 7 that is suitable for the coalescence of water 6 (cf. also FIG. 2). Purely theoretically, the coalescer 4 could undertake not only the coalescence function, but also a filtration, so that in this case no separate particle filter 3 would be provided. The particle filter 3 and the coalescer 4 are flowed through here in a throughflow direction 8. According to the invention, the coalescer material 7 now has fibres 9 whose primary orientation is oriented essentially parallel to the throughflow direction 8. In other words, this means that a longitudinal direction of the individual fibres 9 is oriented predominantly parallel to the throughflow direction 8. A primary orientation of the fibres 9 is not present here only when all the fibres 9 run in a parallel manner, but also already when the running direction of over 50 percent of the fibres 9 have an angle of preferably less than 45 degrees to a direction which then represents the primary orientation. Preferably, even over 80 percent, in particular even over 90 percent, of the fibres 9 have an angle of less than 45 degrees to the throughflow direction 8. Through the fibre orientation or respectively orientation in throughflow direction 8 selected according to the invention, individual water drops 6′ can adhere to the surface of the fibres 9 for a long time and thereby agglomerate and form larger drops. By the fibres 9, oriented in throughflow direction 8, in addition a pressure loss in the coalescer material 7 falls, which has a positive effect on the operation of the fuel filter 1.

The particle filter 3 or respectively the coalescer 4 can be configured in a ring-shaped manner in cross-section (cf. FIGS. 1, 3 and 4). In addition, the coalescer 4 and the particle filter 3 can be combined in a filter element 17.

The fibres 9 preferably have here a diameter D between 1 μm and 30 μm and hereby influence the agglomeration effect in a particularly favourable manner. The fibres 9 of the coalescer material 7 can be configured for example as glass fibres, but also as plastic fibres, in particular polyester fibres, cellulose fibres or metal fibres. The fibre orientation can be realized here via specific production methods, thus for example the fibres 9 are deposited in machine direction onto a screen carrier and are subsequently further oriented in a targeted manner via a so-called comb method (carding) in machine direction (y-direction). Subsequently, the thus produced coalescer material 7 can be folded and laid on block, so that a bellows 13 results, in which the fibres 9 are oriented with regard to their longitudinal direction, i.e. their primary orientation, essentially parallel to the throughflow direction 8.

Particularly preferred methods for the production of the coalescer 4 are described below, in which the coalescer material 7 is produced by means an aerodynamic nonwoven method, for example meltblown or spunbond methods, or of a hydrodynamic nonwoven method (wetlaid nonwovens). The fibres 9 of the coalescer material 7 which are produced here are deposited here in a parallel manner or, with a multidirectional deposition, are additionally carded, in particular combed, and thus oriented essentially parallel to one another. The coalescer material 7 can also be produced by means of knitting, warp-knitting or weaving, wherein a fibre orientation in Z-direction is provided, for example in an analogous manner to other applications, such as for example cleaning cloths, hand towels, etc. In principle, all nonwovens can be used. By the carding it is achieved that the fibres 9 are arranged essentially parallel to one another. Essentially parallel is intended to mean here that at least 50 percent of the fibres 9, preferably 80 percent or even 90 percent of the fibres 9 are oriented parallel to one another or respectively parallel to a primary orientation. Thereby, a coalescer web 10 is produced with fibres 9 running in machine direction (y-direction).

These thus produced coalescer webs 10 can then be further processed as follows:

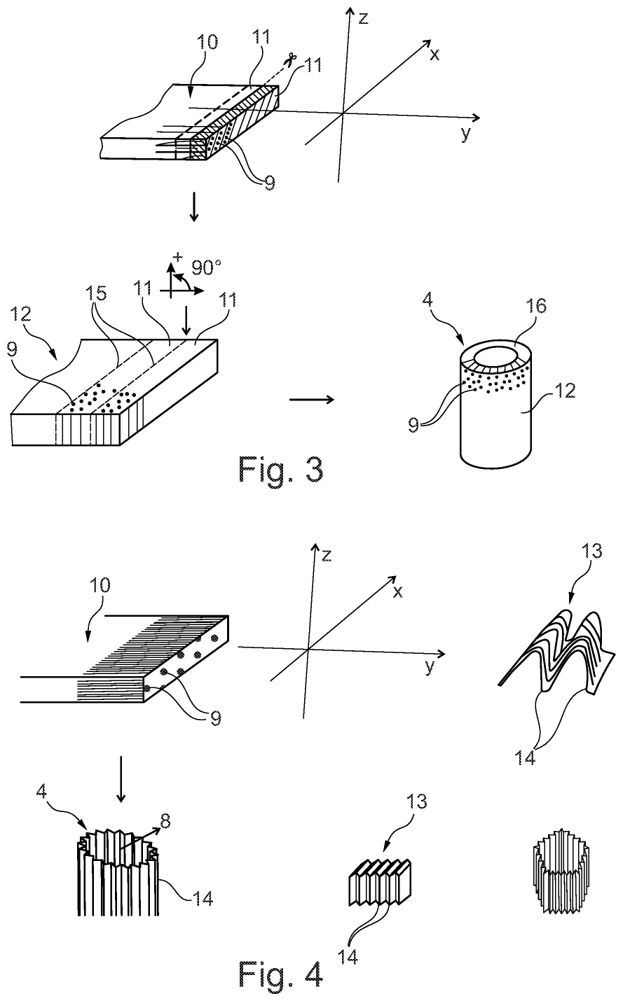

Variant 1 (cf. FIG. 3): Cutting to length the coalescer web 10 transversely to the fibre longitudinal direction (y-direction) into individual coalescer web sections 11, wherein the cut-to-length coalescer web sections are turned through 90° and stuck laterally to one another, so that a coalescer mat 12 results, or

Variant 2 (cf. FIG. 4): Orienting of the fibres 9 in y-direction, i.e. optimizing of the combing with subsequent folding (for orienting in z-direction).

In Variant 2, the produced coalescer web 10 is folded in an alternating manner about an x-axis and thereby a zigzag-shaped folded web is produced, in which the fibre longitudinal direction follows the zigzag shape. Subsequently, this folded web is cut to a bellows 13 and for example stuck into a coalescer frame, wherein an additional on-block pressing of individual folds 14 can take place, in order to be able to bring about an almost parallel orientation of the fibres 9.

The bellows 13 can be heated here, wherein bicomponent fibres are used as fibres 9 which, on heating, bring about a sticking together of individual folds 14 of the bellows 13.

It is essential that the fibres 9 are flowed against in longitudinal direction. In the previously mentioned Variant 2, it is crucial that the folds 14 stand closely to one another, so that the fluid can not flow into the fold 14, but rather is forced to flow through the fold 14 longitudinally and thus also the fibres 9 are flowed against in longitudinal direction.

In Variant 1 the produced coalescer web 10 is cut to length, i.e. cut off, and the cut-to-length coalescer web sections 11 are turned through 90° and are stuck to one another laterally at sites 15, so that a coalescer mat 12 results (cf. FIG. 3). Here, several parallel fibres 9 in z-direction are from an individual fibre 9 in y-direction in the original coalescer web 10. Subsequently the coalescer mat 12 is rolled to a cylindrical ring filter and is stuck together at the ends. The fibres 9 lie here in radial direction (cf. FIG. 1, 3). Purely theoretically, it is of course also conceivable that the coalescer material 7 in the later coalescer 4 is configured as a polygon.

The coalescer webs 10 can also have a respectively outer layer of a hydrophobic spunbond or bico-lattice (bicomponent lattice) and an inner layer of a coalescer nonwoven. On heating, the bico-lattices melt and bring about a sticking together of the individual folds 14 in a coalescer 4 produced according to Variant 2. Such bico-fibres have a more temperature-stable core and a casing of a plastic with a lower melting point, so that with a heating the casing melts and the individual fibres 9 or respectively folds 14 stick together with one another and thereby a stabilizing is brought about, the core, however, remains stable.

Furthermore, the applying of a hydrophilic coating onto a raw side of the bellows 13 is also possible. If the coalescer material 7—as described above—is to be coated with a (hydrophobic) spunbond, it is advantageous to arrange a hydrophilic coating on the onflow side, so that the water drops 9 can penetrate more easily into the fold 14. The hydrophobic spunbond is then between the folds 14, which is intended to prevent the exiting of the drops 9 out of the folds 14.

1. A fuel filter, comprising:
a housing;
a coalescer arranged in the housing, the coalescer configured to separate out water contained in a fuel;
the coalescer including a coalescer material suitable for coalescing water;
wherein the fuel is flowable through the coalescer in a throughflow direction; and
wherein the coalescer material includes a plurality of fibres having a primary orientation that is essentially parallel to the throughflow direction.

2. The fuel filter according to claim 1, further comprising a particle filter, wherein:
the particle filter is configured as a ring filter element; and
the coalescer has a ring-shaped cross-section.

3. The fuel filter according to claim 1, wherein the plurality of fibres have a diameter greater than 1 μm and less than 30 μm.

4. The fuel filter according to claim 1, wherein the plurality of fibres are configured as a plurality of glass fibres.

5. The fuel filter according to claim 1, wherein the plurality of fibres include at least one of plastic, polyester, cellulose, and metal.

6. The fuel filter according to claim 1, wherein the fuel filter is configured as a diesel fuel filter.

7. The fuel filter according to claim 2, wherein the coalescer is arranged downstream of the particle filter relative to the throughflow direction.

8. A method for producing a coalescer for a fuel filter, comprising:
producing a coalescer material via at least one of weaving, knitting, and a nonwoven method;
orienting a plurality of fibres of the coalescer material in an essentially parallel manner to produce a coalescer web; and
at least one of:
producing a coalescer mat via (i) cutting the coalescer web into a plurality of individual cut-to-length coalescer web sections, the coalescer web cut in a direction extending transversely to a fibre longitudinal direction, (ii) turning the plurality of cut-to-length coalescer web sections 90°, and (iii) sticking the plurality of cut-to-length coalescer web sections to one another laterally; and
producing a bellows via folding the coalescer web in a zigzag-shaped manner.

9. The method according to claim 8, wherein the method includes producing the coalescer mat, and the method further comprises sticking ends of the coalescer mat together to form the coalescer mat into a closed ring in which the plurality of fibres are oriented essentially in a radial direction of the closed ring.

10. The method according to claim 8, wherein:
the method includes producing the bellows; and
producing the bellows includes pressing the bellows on block.

11. The method according to claim 10, wherein:
the plurality of fibres includes a plurality of bicomponent fibres; and
the method further comprises sticking together individual folds of the bellows via heating the plurality of bicomponent fibres.

12. The method according to claim 11, wherein:
each of the plurality of bicomponent fibres includes a temperature-stable core surrounded by a plastic casing; and
heating the plurality of bicomponent fibres includes melting the plastic casings of the plurality of bicomponent fibres.

13. The method according to claim 11, further comprising applying a hydrophilic coating onto a raw side of the bellows.

14. The method according to claim 8, wherein orienting the plurality of fibres includes carding the plurality of fibres such that at least 50% of the plurality of fibres are oriented parallel to one another.

15. The method according to claim 8, wherein orienting the plurality of fibres includes combing the plurality of fibres such that at least 80% of the plurality of fibres are oriented parallel to one another.

16. A fuel filter, comprising:
a housing;
a coalescer arranged in the housing, the coalescer configured to separate out water contained in a fuel flowable through the coalescer in a throughflow direction;
the coalescer including a coalescer material for coalescing water;
the coalescer material including a plurality of fibres; and
wherein at least 50% of the plurality of fibres are oriented at an angle of less than 45° relative to the throughflow direction.

17. The fuel filter according to claim 1, wherein the plurality of fibres includes a plurality of bicomponent fibres each including a temperature-stable core surrounded by a plastic casing.

18. The fuel filter according to claim 1, wherein at least 80% of the plurality of fibres are oriented parallel to one another.

19. The fuel filter according to claim 1, wherein at least 50% of the plurality of fibres are oriented at an angle of less than 45° relative to the throughflow direction.

20. The fuel filter according to claim 2, further comprising a filter element including the coalescer and the particle filter.
